(19) United States
(12) Patent Application Publication
(10) Pub. No.: US 2015/0167545 A1
(43) Pub. Date: Jun. 18, 2015

(54) Rotary Engine Assembly

(71) Applicant: Olexiy Surgay, Sedalia, MO (US)

(72) Inventor: Olexiy Surgay, Sedalia, MO (US)

(21) Appl. No.: 14/132,916

(22) Filed: Dec. 18, 2013

(51) Int. Cl. F02B 53/12

(52) U.S. Cl. CPC F02B 53/12

(57) ABSTRACT

A rotary engine assembly for producing a rotational torque includes a cylindrical housing. A shaft is operationally coupled to the cylindrical housing. A cylindrical rotor is coupled to the shaft. The cylindrical rotor is positioned within an interior of the cylindrical housing. A force plate is operationally coupled to the cylindrical rotor. An intake is operationally coupled to the cylindrical housing. A fuel is delivered into the interior of the cylindrical housing. The force plate compresses the fuel. An exhaust is operationally coupled to said cylindrical housing. Burnt fuel is expelled from the cylindrical housing. A combustion chamber is operationally coupled to the cylindrical housing. The combustion chamber receives the compressed fuel. A spark plug is coupled to said combustion chamber. The spark plug selectively ignites the compressed fuel in the combustion chamber. The ignited fuel urges the force plate into the exhaust cycle.

### BACKGROUND OF THE DISCLOSURE

### Field of the Disclosure

The disclosure relates to rotary engine devices and more particularly pertains to a new rotary engine device for producing a rotational torque.

### SUMMARY OF THE DISCLOSURE

An embodiment of the disclosure meets the needs presented above by generally comprising a cylindrical housing. A lid is coupled to the cylindrical housing. A shaft is operationally coupled to the lid. The shaft extends through the cylindrical housing. A cylindrical rotor is coupled to the shaft. The cylindrical rotor is positioned within an interior of the cylindrical housing. A force plate is operationally coupled to the cylindrical rotor. The force plate engages the cylindrical housing and the force plate alternatively moves through a compression cycle and an exhaust cycle. An intake is operationally coupled to the cylindrical housing. A fuel is delivered into the interior of the cylindrical housing. The force plate compresses the fuel in the compression cycle. An exhaust is operationally coupled to said cylindrical housing. Burnt fuel is expelled from the cylindrical housing when the force plate moves through the exhaust cycle. A combustion chamber is operationally coupled to the cylindrical housing. The combustion chamber receives the compressed fuel in the cylindrical housing. A spark plug is coupled to said combustion chamber. The spark plug selectively ignites the compressed fuel in said combustion chamber. The ignited fuel is expelled into said cylindrical housing and the ignited fuel urges said force plate into the exhaust cycle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a rotary engine assembly according to an embodiment of the disclosure.

FIG. 2 is an perspective view of an embodiment of the disclosure.

FIG. 3 is an exploded view of an embodiment of the disclosure.

FIG. 4 is a cross sectional view taken along line 4-4 of FIG. 1 of an embodiment of the disclosure.

FIG. 5 is an alternative cross sectional view taken along line 4-4 of an embodiment of the disclosure

### DESCRIPTION OF THE PREFERRED EMBODIMENT

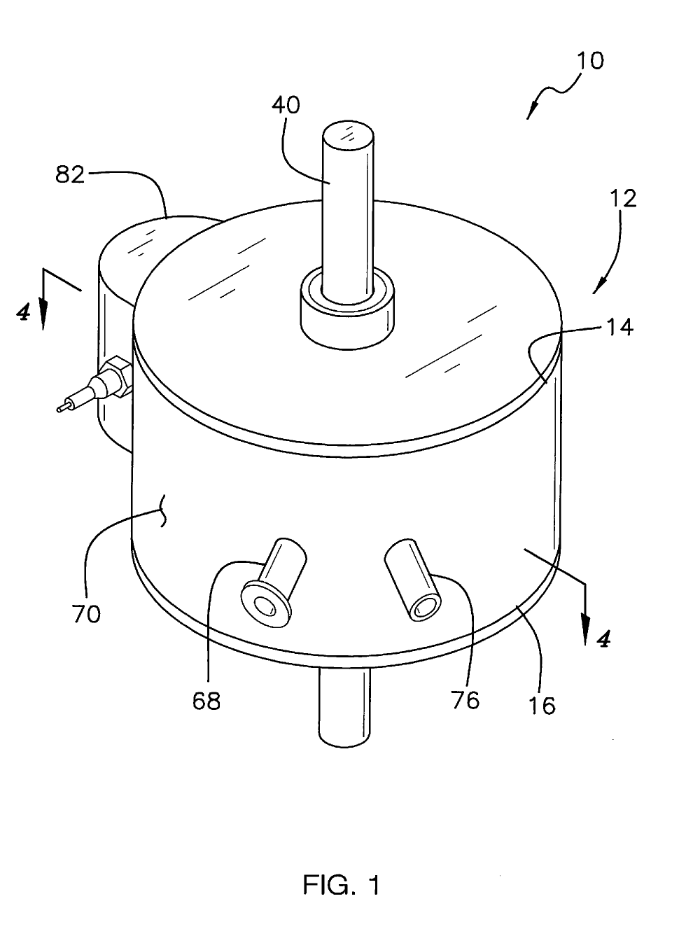

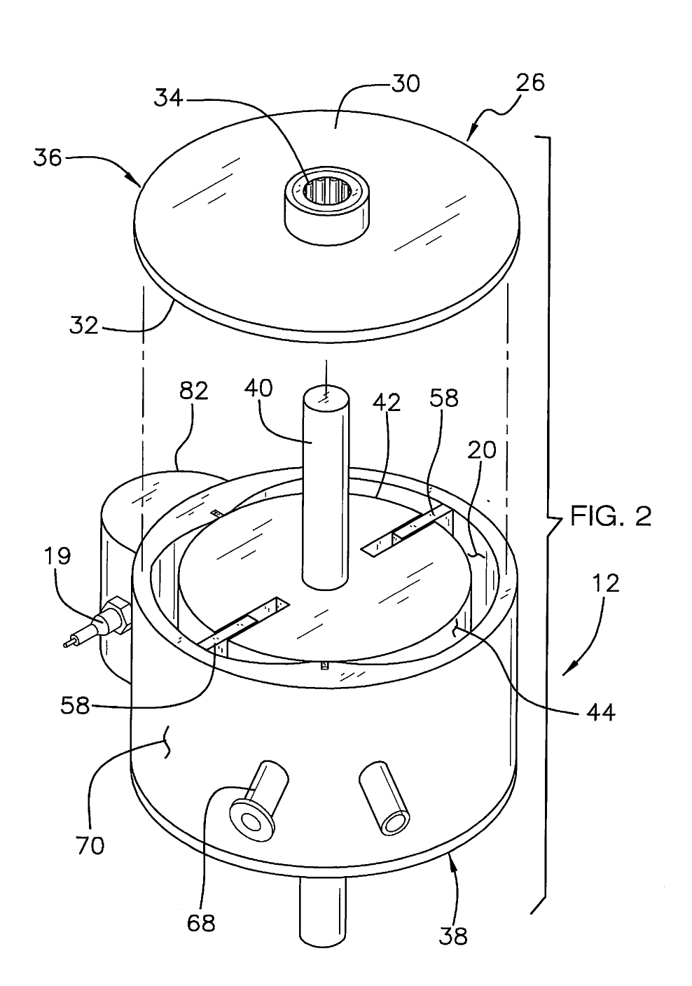

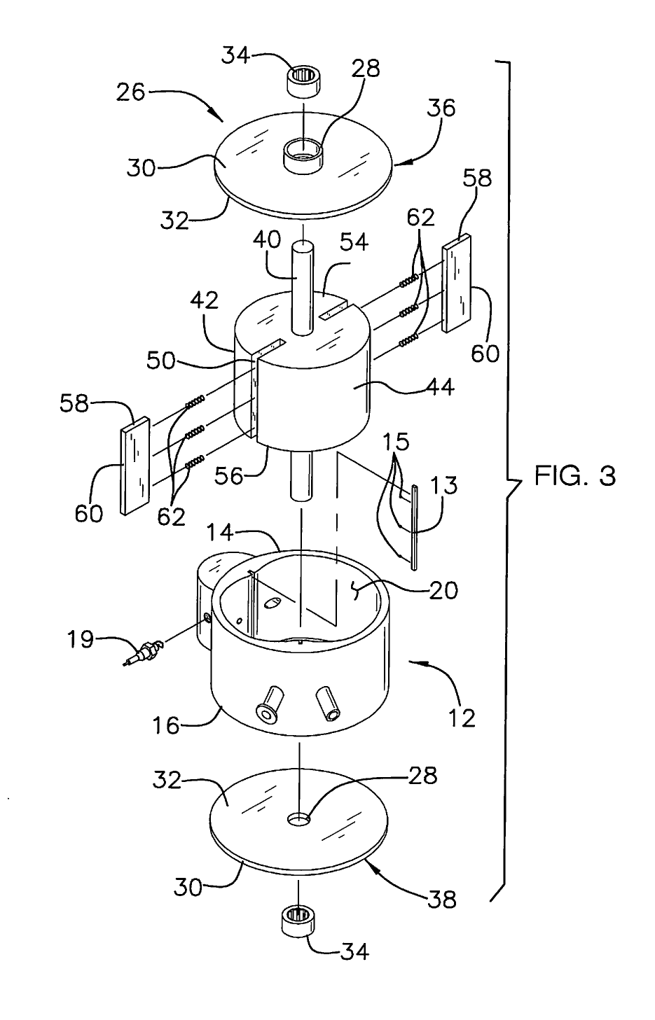

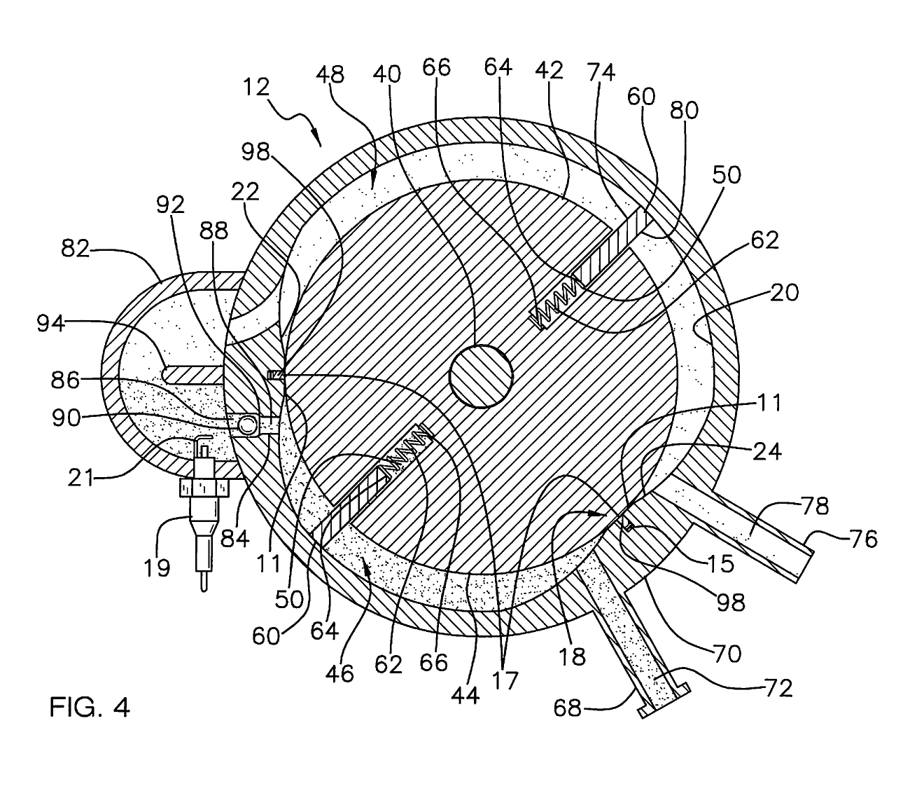

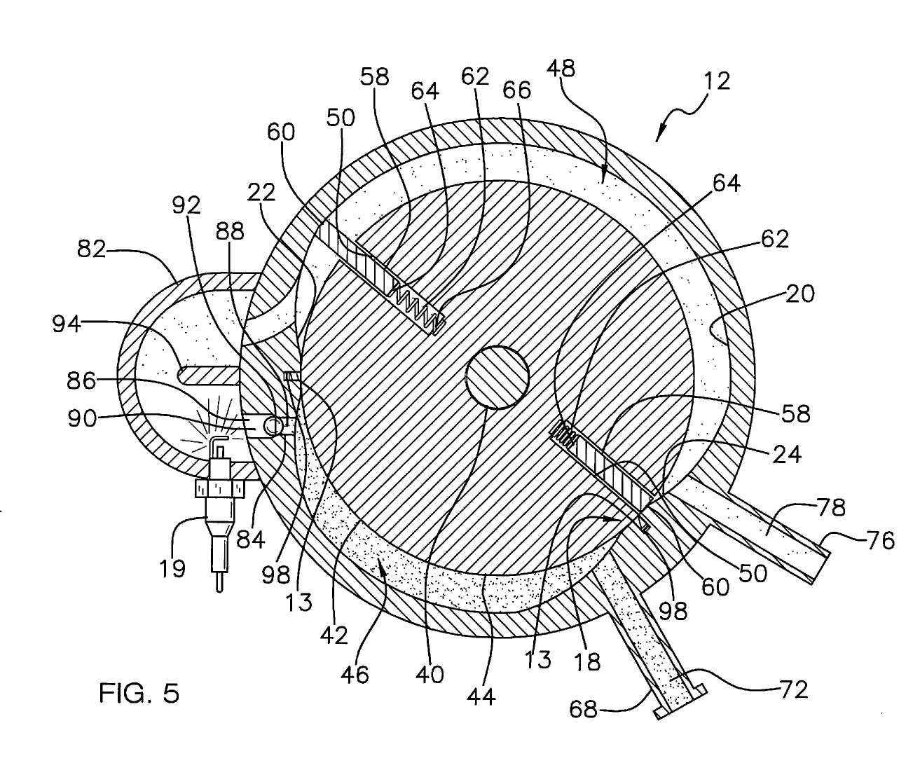

With reference now to the drawings, and in particular to FIGS. 1 through 5 thereof, a new rotary engine device embodying the principles and concepts of an embodiment of the disclosure and generally designated by the reference numeral 10 will be described.

As best illustrated in FIGS. 1 through 5, the rotary engine assembly 10 generally comprises a cylindrical housing 12 that has an open top end 14 and an open bottom end 16. The cylindrical housing 12 may have a height between 15 cm and 25 cm and an inside diameter between 15 cm and 25 cm. A prominence 18 extends inwardly from an inside surface 20 of the cylindrical housing 12. The prominence 18 extends between the open top end 14 and the open bottom end 16 of the cylindrical housing 12. Additionally, the prominence 18 may have a height between 1 cm and 2 cm. The prominence 18 is one of pair of the prominences 18. A first one of the pair of prominences 22 is spaced between 135 degrees and 140 degrees of clockwise rotation away from a second one of the pair of prominences 24.

A lid 26 is coupled to the cylindrical housing 12. Continuing, a shaft aperture 28 extends through a top side 30 and a bottom side 32 of the lid 26. A bearing 34 is coupled to the top side 30 of the lid 26 so the bearing 34 is aligned with the shaft aperture 28. The bearing 34 may be a friction reducing bearing of any conventional design. Additionally, the lid 26 is one of a pair of the lids 26. A top one of the pair of lids 36 is removably coupled to the open top end 14 of the cylindrical housing 12. Further, a bottom one of the pair of lids 38 is removably coupled to the open bottom end 16 of the cylindrical housing 12.

A shaft 40 extends through each of the top 36 and bottom 38 lids. The bearing 34 on each of the top 36 and bottom 38 lids retains the shaft 40 in a center of the interior of the cylindrical housing 12. Moreover, the shaft 40 may have a length between 20 cm and 30 cm. A cylindrical rotor 42 is coupled to the shaft 40. Continuing, the cylindrical rotor 42 is positioned within an interior of the cylindrical housing 12. An outer surface 44 of the cylindrical rotor 42 engages each of the first 22 and second 24 prominences. Moreover, a compression space 46 is defined between the first 22 and second 24 prominences moving in a clockwise rotation. Lastly, an exhaust space 48 is defined between the second 24 and first 22 prominences moving in a clockwise rotation.

A primary groove 50 extends into the outer surface 44 of the cylindrical rotor 42. Additionally, the primary groove 50 extends between a top end 54 and a bottom end 56 of the cylindrical rotor 42. The primary groove 50 is one of a pair of the primary grooves 50 each positioned on opposite sides of the cylindrical rotor 42. Finally, each of the pair of primary grooves 50 may have a depth between 5 cm and 10 cm.

A force plate 58 is positioned within the primary groove 50 in the cylindrical rotor 42. Moreover, the force plate 58 extends between the top 54 and bottom 56 ends of the cylindrical rotor 42. A first lateral edge 60 of the force plate 58 abuts the inside surface 20 of the cylindrical housing 12. Continuing, the force plate 58 moves through a compression cycle when the force plate 58 passes through the compression space 46 in the clockwise rotation. The force plate 58 moves through an exhaust cycle when the force plate 58 passes through the exhaust space 48 in the clockwise rotation. Lastly, the force plate 58 may have a depth between 5 cm and 10 cm.

A spring biasing member 62 is positioned between a second lateral edge 64 of the force plate 58 and an inside wall 66 of the primary groove 50. Moreover, the spring biasing member 62 biases the force plate 58 outwardly from the primary groove 50. The spring biasing member 62 urges the first lateral edge 60 of the force plate 58 against the inside surface 20 of the cylindrical housing 12. Continuing, an air tight seal is formed between the first lateral edge 60 of the force plate 58 and the inside surface 20 of the cylindrical housing 12. The force plate 58 is one of a pair of the force plates 58 each positioned within an associated one of the pair of the primary grooves 50. Lastly, the spring biasing member 62 is one of a plurality of spring biasing members 62.

An intake 68 is coupled to an outside surface 70 of the cylindrical housing 12 proximate the first prominence 22. The intake 68 is in fluid communication with the compression space 46. Moreover, a fuel 72 is delivered into the compression space 46 so each of the pair of force plates 58 compresses the fuel 72 in the associated compression cycle of each of the pair of force plates 58. As each of the pair of force plates 58 rotates past the intake 68 in the compression cycle, the associated force plate 58 creates a negative pressure in the compression space 46 between a back side 74 of the force plate 58 and the intake 68. The negative pressure in the compression space 46 draws the fuel 72 into the compression space 46 through the intake 68. The fuel 72 may be an air/fuel mixture of gasoline or other similar combustible fuel.

An exhaust 76 is coupled to the outside surface 70 of the cylindrical housing 12 proximate the first prominence 22. The exhaust 76 is in fluid communication with the exhaust space 48. Moreover, burnt fuel 78 is expelled from the cylindrical housing 12 when the each of the pair of force plates 58 moves through the associated exhaust cycle. As each of the pair of force plates 58 rotates past the second prominence 24 in the exhaust cycle, the associated force plate 58 creates a positive pressure in the exhaust space 48 between a front side 80 of the force plate 58 and the exhaust 76. The positive pressure in the exhaust space 48 forces the burnt fuel 78 through the exhaust 76.

A combustion chamber 82 is coupled to the outside surface 70 of the cylindrical housing 12. The combustion chamber 82 is aligned with the second prominence 24. Continuing, a fuel aperture 84 extends through the cylindrical housing 12. The fuel aperture 84 extends between the compression space 46 and an interior of the combustion chamber 82. A first portion 86 of the fuel aperture 84 has a diameter that is greater than a second portion 88 of the fuel aperture 84.

A check valve 90 is movably positioned within the first portion 86 of the fuel aperture 84. Further, the check valve 90 is selectively seated against a bottom side 92 of the first portion 86 of the fuel aperture 84 when the check valve 90 is in a closed position. The check valve 90 is moved away from the bottom side 92 of the first portion 86 of the fuel aperture 84 when the check valve 90 is in an open position. The combustion chamber 82 is in fluid communication with the compression space 46 when the check valve 90 is in the open position. Further, the combustion chamber 82 is discrete from the compression space 46 when the check valve 90 is in the closed position.

As each of the pair of force plates 58 rotates through the compression space in the compression cycle, the associated force plate 58 creates a positive pressure between the front side 80 of the force plate 58 and the check valve 90. The positive pressure urges the check valve 90 into the open position. Moreover, the combustion chamber 82 receives the compressed fuel 72 in the compression space 46 as the associated one of the pair of force plates 58 moves through the compression cycle. Lastly, the check valve 90 may be a ball with a diameter between 1 cm and 2 cm.

A divider 94 is coupled to and extends outwardly from the outside surface 70 of the cylindrical housing 12. Further, the divider 94 is positioned within an interior of the combustion chamber 82 such that the divider 94 is positioned between the fuel aperture 84 and an exhaust aperture 96. The exhaust aperture 96 extends through the cylindrical housing 12. Continuing, the exhaust aperture 96 extends between the exhaust space 48 and the interior of the combustion chamber 82. Moreover, the combustion chamber 82 is in fluid communication with the exhaust space 48.

A secondary groove 98 extends into the inside surface 20 of the cylindrical housing 12. The secondary groove 98 extends between the open top 14 and bottom 16 ends of the cylindrical housing 12. Continuing, the secondary groove 98 may have a depth between 2 mm and 4 mm. The secondary groove 98 is one of a pair of the secondary grooves 98 each positioned on an apex 11 of an associated one of the first 22 and second 24 prominences. A seal plate 13 is positioned within the secondary groove 98. The seal plate 13 extends between the open top 14 and bottom 16 ends of the cylindrical housing 12.

A spring biasing member 15 is positioned between the seal plate 13 and an inside wall 15 of the secondary groove 98. The spring biasing member 15 biases the seal plate 13 outwardly from the secondary groove 98. Moreover, the seal plate 13 is one of a pair of the seal plates 13 each positioned within an associated one of a pair of secondary grooves 98. A first lateral edge 17 of each of the pair of seal plates 13 engages the outer surface 52 of the cylindrical rotor 42 so the compression space 46 is discrete from the exhaust space 48. Lastly, the pair of seal plates 13 forms an air tight seal with the outer surface 52 of the cylindrical rotor 42.

A spark plug 19 is coupled to the combustion chamber 82. An ignition end 21 of the spark plug 19 is positioned within an interior of the combustion chamber 82. Continuing, the spark plug 19 selectively ignites the compressed fuel 72 in the combustion chamber 82. When the compressed fuel 72 in the combustion chamber 82 is ignited, the positive pressure of the burnt fuel 78 urges the check valve 90 into the closed position.

The spark plug 19 ignites the compressed fuel 72 in the combustion chamber 82 when an associated one of the pair of force plates 58 rotates past the exhaust aperture 96. Further, the burnt fuel 78 is expelled into the exhaust space 48 through the exhaust aperture 96. The positive pressure of the burnt fuel 78 exerts a force on the back side 74 of the associated force plate 58 and urges the associated force plate 58 into the exhaust cycle. Additionally, the rotational force transferred into the cylindrical rotor 42 urges the other of the pair of force plates 58 into the compression cycle.

In use, an initial rotational force is applied to the shaft 40. The initial rotational force rotates the cylindrical rotor 42 within the cylindrical housing 12. After the spark plug 19 ignites the compressed fuel 72 for the first time, the cylindrical rotor 42 is rotated through the rapid expansion of the burnt fuel 78. The shaft 40 may be operationally coupled to an object in order to transfer the rotational torque of the shaft 40 into the object. The object may be a machine of any conventional design or any other object that utilizes rotational torque.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A rotary engine assembly for producing a rotational torque, said assembly comprising:
a cylindrical housing;
a lid coupled to said cylindrical housing
a shaft operationally coupled to said lid wherein said shaft extends through said cylindrical housing;
a cylindrical rotor coupled to said shaft wherein said cylindrical rotor is positioned within an interior of said cylindrical housing;
a force plate operationally coupled to said cylindrical rotor wherein said force plate engages said cylindrical housing wherein said force plate alternatively moves through a compression cycle and an exhaust cycle;
an intake operationally coupled to said cylindrical housing wherein a fuel is delivered into the interior of said cylindrical housing wherein said force plate compresses the fuel in said compression cycle;
an exhaust operationally coupled to said cylindrical housing wherein burnt fuel is expelled from said cylindrical housing when said force plate moves through said exhaust cycle;
a combustion chamber operationally coupled to said cylindrical housing wherein said combustion chamber receives the compressed fuel in said cylindrical housing; and
a spark plug coupled to said combustion chamber wherein said spark plug selectively ignites the compressed fuel in said combustion chamber wherein the ignited fuel is expelled into said cylindrical housing wherein the ignited fuel urges said force plate into said exhaust cycle.

2. The assembly according to claim 1 further comprising said cylindrical housing having an open top end and an open bottom end.

3. The assembly according to claim 1 further comprising:
a prominence extending inwardly from an inside surface of said cylindrical housing wherein said prominence extends between an open top end and an open bottom end of said cylindrical housing;
said prominence being one of pair of said prominences; and
a first one of said pair of prominences being spaced 135 degrees of clockwise rotation away from a second one of said pair of prominences.

4. The assembly according to claim 1 further comprising:
said lid being one of a pair of said lids;
a top one of said pair of lids being removably coupled to an open top end of said cylindrical housing; and
a bottom one of said pair of lids being removably coupled to an open bottom end of said cylindrical housing.

5. The assembly according to claim 1 further comprising said shaft extending through each of a top lid and a bottom lid wherein said shaft is positioned in a center of the interior of said cylindrical housing.

6. The assembly according to claim 1 further comprising an outer surface of said cylindrical rotor engaging each of a first and a second prominence wherein a compression space is defined between said second and first prominences wherein an exhaust space is defined between said first and second prominences.

7. The assembly according to claim 1 further comprising:
a primary groove extending into an outer surface of said cylindrical rotor wherein said primary groove extends between a top end and a bottom end of said cylindrical rotor; and
said primary groove being one of a pair of said primary grooves each being positioned on opposite sides of said cylindrical rotor.

8. The assembly according to claim 1 further comprising:
said force plate being positioned within a primary groove in said cylindrical rotor wherein said force plate extends between a top end and a bottom end of said cylindrical rotor wherein a first lateral edge of said force plate abuts an inside surface of said cylindrical housing;
a spring biasing member positioned between a second lateral edge of said force plate and an inside wall of said primary groove wherein said spring biasing member biases said force plate outwardly from said primary groove; and
said force plate being one of a pair of said force plates each positioned within an associated one of a pair of said primary grooves.

9. The assembly according to claim 1 further comprising said intake being coupled to an outside surface of said cylindrical housing proximate a first prominence wherein said intake is in fluid communication with a compression space.

10. The assembly according to claim 1 further comprising said exhaust being coupled to an outside surface of said cylindrical housing proximate a first prominence wherein said exhaust is in fluid communication with an exhaust space.

11. The assembly according to claim 1 further comprising:
said combustion chamber being coupled to an outside surface of said cylindrical housing wherein said combustion chamber is aligned with a second prominence;
a fuel aperture extending through said cylindrical housing wherein said fuel aperture extends between a compression space and an interior of said combustion chamber wherein said combustion chamber is in fluid communication with said compression space; and
an exhaust aperture extending through said cylindrical housing wherein said exhaust aperture extends between an exhaust space and said interior of said combustion chamber wherein said combustion chamber is in fluid communication with said exhaust space.

12. The assembly according to claim 1 further comprising:
a secondary groove extending into an inside surface of said cylindrical housing wherein said secondary groove extends between an open top end and an open bottom end of said cylindrical housing; and
said secondary groove being one of a pair of said secondary grooves each positioned on an apex of an associated one of a first prominence and a second prominence.

13. The assembly according to claim 1 further comprising:
a seal plate positioned within a secondary groove wherein said seal plate extends between an open top end and an open bottom end of said cylindrical housing;
a spring biasing member positioned between said seal plate and an inside wall of said secondary groove wherein said spring biasing member biases said seal plate outwardly from said secondary groove;
said seal plate being one of a pair of said seal plates each positioned within an associated one of a pair of secondary grooves; and
a first lateral edge of each of said pair of seal plates engaging an outer surface of said cylindrical rotor wherein a compression space is discrete from an exhaust space.

14. A rotary engine assembly for producing a rotational torque, said assembly comprising:
a cylindrical housing having an open top end and an open bottom end;
a prominence extending inwardly from an inside surface of said cylindrical housing wherein said prominence extends between said open top end and said open bottom end of said cylindrical housing, said prominence being one of pair of said prominences;
a first one of said pair of prominences being spaced 135 degrees of clockwise rotation away from a second one of said pair of prominences;
a lid coupled to said cylindrical housing, said lid being one of a pair of said lids;
a top one of said pair of lids being removably coupled to said open top end of said cylindrical housing;
a bottom one of said pair of lids being removably coupled to said open bottom end of said cylindrical housing;
a shaft extending through each of said top and bottom lids wherein said shaft is positioned in a center of the interior of said cylindrical housing;
a cylindrical rotor coupled to said shaft wherein said cylindrical rotor is positioned within an interior of said cylindrical housing, an outer surface of said cylindrical rotor engaging each of a first and a second prominence wherein a compression space is defined between said second and first prominences wherein an exhaust space is defined between said first and second prominences;
a primary groove extending into an outer surface of said cylindrical rotor wherein said primary groove extends between a top end and a bottom end of said cylindrical rotor, said primary groove being one of a pair of said primary grooves each being positioned on opposite sides of said cylindrical rotor;
a force plate being positioned within said primary groove in said cylindrical rotor wherein said force plate extends between said top and bottom ends of said cylindrical rotor wherein a first lateral edge of said force plate abuts said inside surface of said cylindrical housing wherein said force plate alternatively moves through a compression cycle and an exhaust cycle;
a spring biasing member positioned between a second lateral edge of said force plate and an inside wall of said primary groove wherein said spring biasing member biases said force plate outwardly from said primary groove;
said force plate being one of a pair of said force plates each positioned within an associated one of said pair of said primary grooves;
an intake coupled to an outside surface of said cylindrical housing proximate said first prominence wherein said intake is in fluid communication with said compression space wherein a fuel is delivered into said compression space wherein said pair of force plates each compresses the fuel in said compression cycle;
an exhaust coupled to said outside surface of said cylindrical housing proximate said first prominence wherein said exhaust is in fluid communication with said exhaust space wherein burnt fuel is expelled from said cylindrical housing when said pair of force plates moves through said exhaust cycle;
a combustion chamber coupled to said outside surface of said cylindrical housing wherein said combustion chamber is aligned with said second prominence;
a fuel aperture extending through said cylindrical housing wherein said fuel aperture extends between said compression space and an interior of said combustion chamber wherein said combustion chamber is in fluid communication with said compression space wherein said combustion chamber receives the compressed fuel in said compression space; and
an exhaust aperture extending through said cylindrical housing wherein said exhaust aperture extends between said exhaust space and said interior of said combustion chamber wherein said combustion chamber is in fluid communication with said exhaust space;
a secondary groove extending into said inside surface of said cylindrical housing wherein said secondary groove extends between said open top and bottom ends of said cylindrical housing, said secondary groove being one of a pair of said secondary grooves each positioned on an apex of an associated one of said first prominence and said second prominence;
a seal plate positioned within said secondary groove wherein said seal plate extends between said open top and bottom ends of said cylindrical housing;
a spring biasing member positioned between said seal plate and an inside wall of said secondary groove wherein said spring biasing member biases said seal plate outwardly from said secondary groove;
said seal plate being one of a pair of said seal plates each positioned within an associated one of a pair of secondary grooves, a first lateral edge of each of said pair of seal plates engaging said outer surface of said cylindrical rotor wherein said compression space is discrete from said exhaust space; and
a spark plug coupled to said combustion chamber wherein said spark plug selectively ignites the compressed fuel in said combustion chamber wherein the ignited fuel is expelled into said cylindrical housing wherein the ignited fuel urges an associated one of said pair of force plates into said exhaust cycle.
